(19) United States
(12) Patent Application Publication
(10) Pub. No.: US 2003/0135825 A1
(43) Pub. Date: Jul. 17, 2003

(54) Dynamically generated mark-up based graphical user interfaced with an extensible application framework with links to enterprise resources

(76) Inventors: Matthew Gertner, Prague (CZ); Arseniy Kuznetsov, Prague (CZ); Ondrej Rypacek, Prague (CZ)

Correspondence Address: DICKSTEIN SHAPIRO MORIN & OSHINSKY LLP, 2101 L STREET NW, WASHINGTON, DC, 20037-1526, US

(21) Appl. No.: 10/309,056

(22) Filed: Dec. 4, 2002

Related U.S. Application Data
(60) Provisional application No. 60/335,833, filed on Dec. 5, 2001.

(51) Int. Cl. G06F 15/00

(52) U.S. Cl. 715/513

(57) ABSTRACT

A method, apparatus, and article of manufacture for generating a Markup-based Graphical User Interface (application) within extensible application framework and links to enterprise resources based on variety of XML Schema languages such as DTD, SOX, and XSDL. XML Schemas provide a description of application data structures and are used to generate automatically an application interface allowing a user to display and modify conformant data via a web browser or mobile device. While XML Schemas define generic data structure, application specific information is delivered using Schema Adjuncts.

### BACKGROUND OF THE INVENTION

1. Field of the Invention

The present invention relates generally to computerized methods for accessing XML data structures, and in particular, to methods for automatically generating a Markup-based Graphical User Interface (application) within an extensible application framework with links to enterprise resources using Schema Annotations (Schema Adjuncts) for specifying application-specific behavior.

2. Description

It is a well-known technique to use data meta-definitions for the automatic generation of an application framework and has been utilized for years in a variety of software development tools, such as Microsoft Visual Basic, Borland Delphi, and Sybase PowerBuilder, where most of those tools use data models provided by relational databases, such as Oracle, Sybase and Informix. While the tabular data model used by RDBMS has compelling advantages when used for certain purposes, the same data model is totally inappropriate for many application-level tasks. On the other hand, XML schemas provide a universal application-level model, a precondition for creating universal mapping technology. For example, XML schemas share the hierarchical data model of application data structures. XML schemas make it possible to provide generic solutions to some of software development's hardest problems like GUI development, database integration, and inter-application communication. Therefore, solving the problem of XML metadata-driven GUIs would eliminate one of the most cumbersome aspects of modern software development.

As stated above, currently there is a need to utilize XML Schema libraries for automatically generating applications specially to the needs of electronic business. However, there are very few or no appropriate tools available to assist developers.

The present invention advantageously improves upon the above-described approaches adding significant additional functionality and features either not provided in the above approaches or provided in a limited or otherwise insufficient way.

### BRIEF SUMMARY OF THE INVENTION

To overcome the limitations in the conventional methods described above, and to overcome other limitations that will become apparent upon reading and understanding the present specification, the present invention discloses a method, apparatus, and article of manufacture for generating a web-based Graphical User Interface (application) within an extensible application framework with links to enterprise resources, based on variety of XML Schema languages such as DTD, SOX, and XSDL.

Various advantages and novel features characterizing the invention are pointed out specifically in the claims annexed hereto and form a part hereof. However, for a better understanding of the invention, its advantages, and the objects obtained by its use, reference should be made to the drawings which form a further part hereof, in which there is illustrated and described specific examples of an apparatus in accordance with the invention.

### BRIEF DESCRIPTION OF THE DRAWINGS

FIG. 1 is a schematic block diagram showing a computer system in which the present invention may be embodied;

FIG. 2 is a block diagram illustrating a layered processing model used in the object framework of the present invention;

FIG. 3 is a flowchart illustrating the steps performed by the application program and object framework using the present invention;

FIG. 4 is a comparison of two ExDOMs for a single instance;

FIG. 5 is a complete ExDOM (black dots are OccurrenceNodes);

FIG. 6 is the internal mechanism used for ExDOM lazy loading;

FIG. 7 illustrates the overall processing of an ExDOM tree by various Output Components;

### DETAILED DESCRIPTION OF THE INVENTION

The following description of the presently contemplated best mode of practicing the invention is not to be taken in a limiting sense, but is made merely for the purpose of describing the general principles of the invention. The scope of the invention should be determined with reference to the claims.

In the following description of the preferred embodiment, reference is made to the accompanying drawings, which form a part hereof, and in which is shown by way of illustration a specific embodiment in which the invention may be put into practice. It is to be understood that other embodiments may be utilized and structural changes may be made without departing from the scope of the present invention.

At the outset, it is helpful to clarify the general meanings of terms used in connection with the description of the invention. The term “W3C” is the World Wide Web Consortium. The term “XML” describes eXtensible Markup Language, recommended by the World Wide Web Consortium (W3C). XML is a subset of SGML (Structured Generalized Markup Language), optimized for delivery over the web. Unlike HyperText Markup Language (HTML), which tags elements in web pages for presentation by a browser, XML tags elements as data. Document Type Definition (“DTD”) as used herein, describes the process by which XML leaves the specification of the tags and how they can be used to the user. Tags may be defined by using them in an XML document or they may be formally defined in a Document Type Definition (DTD).

A software component that enables access to XML Documents Data is called an “XML Parser.” Basically, there are two kinds of parsers which provide SAX and DOM interfaces respectively. SAX is a standard interface for event-based XML parsing, developed collaboratively by the members of the XML-DEV mailing list. SAX is an event-based API, which reports parsing events (such as the start and end of elements) directly to the application through callbacks, and does not usually build an internal tree. The application implements handlers to deal with the different events much like handling events in a graphical user interface. The Document Object Model (DOM) is an application programming interface (API) for HTML and XML documents. It defines the logical structure of documents and the way a document is accessed and manipulated. DOM is based on an object structure that closely resembles the structure of the documents it models.

The eXtensible Stylesheet Language, “XSL”, provides for stylesheets that transform XML into HTML or other text-based formats, rearrange or filter data, or convert it to XML that conforms to another DTD, an important capability for allowing different applications to share data. XSL Transformation (“XSLT”) is designed for use as part of XSL, which is a stylesheet language for XML. In addition to XSLT, XSL includes an XML vocabulary for specifying formatting. XSL specifies the styling of an XML document by using XSLT to describe how the document is transformed into another XML document that uses the formatting vocabulary. XPath is a language for addressing parts of an XML document, designed to be used with XSLT and recommended by the World Wide Web Consortium (W3C).

PCDATA, parsable character data, is a part of an XML document and should be analyzed by an XML parser. Characters “&&”, “<”, and “>” are not allowed. CDATA, character data, is a part of an XML document, which has to be ignored by a XML parser. Characters “&&”, “<”, and “>” are therefore allowed in this part.

“SOX” is a schema for Object-Oriented XML, Schema Language introduced by Commerce One. XSDL is XML Schema Definition Language, standard ratified by the World Wide Web Consortium (W3C). ExDOM (Extended DOM Tree) is memory-resident tree-based representation of an XML document. It extends the standard DOM (Document Object Model). Because processing instances in the present invention require frequent, context-sensitive access to schema information, the ExDOM includes additional nodes that correspond to structures that are present in the schema but only implicit in the document instance. In the present invention, ExDOM implementation fully supports a lazy loading model.

Output is a special algorithm, instantiated as an object within the Output Generator Component object framework, which processes an in-memory ExDOM tree in order to convert specific types of XML tree structures into output formats such as HTML and thus produce Markup-based Graphical User Interface (application). Output Components can contain another Output Components. While from the implementation viewpoint, Output Components are algorithms, their presentation in terms of using the present invention for application development is fully conformant to the object-oriented paradigm. Schema Adjuncts are the standard proposed to W3C by Extensibility, which describes the specific approach to augmenting XML Schemas with extra information. A Command Processor is a custom server-side component implementing a specific interface to ensure compatibility with the computational model of the present invention. It allows for extending the model with custom business logic including access to enterprise resources.

The present invention provides a method for dynamically generating a Markup-based Graphical User Interface, by processing generic application data structures described with XML Schemas along with application specific information contained in Schema Annotations, also called Schema Adjuncts. Schema Adjuncts is an XML based language used to associate domain-specific data with schemas and schema respective instances. Using the generated forms and pages, the present invention not only supports all feasible operations (i.e., display, update, etc.) on the underlying data but also guides the user through the application metadata even if the user has no prior knowledge of the complicated hierarchical structures.

The generic application program and objects framework can be easily used in a number of different environments and application platform such as SUN J2EE, Microsoft COM/DCOM/COM++ and Microsoft .NET. With this invention, customers can leverage their business data using the latest internet technology, without relying on legacy application programs and without developing new application programs.

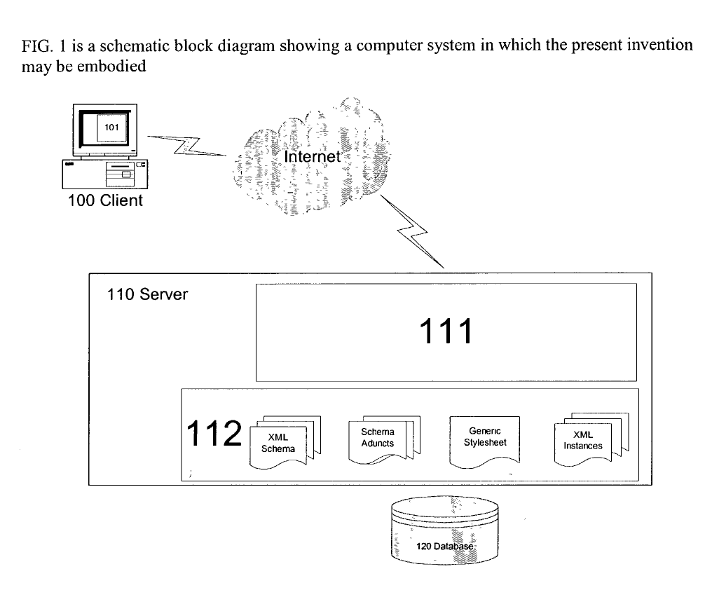

Now referring to the figures, FIG. 1 is a block diagram illustrating an exemplary hardware environment used to implement a preferred embodiment of the invention. A client computer 100 communicates with a server computer 110 (Web Server). Both the client computer 100 and the server computer 110 are typically comprised of one or more processors, random access memory (RAM), read-only memory (ROM), and other components such data storage devices and data communications devices. The client computer 100 executes one or more computer programs 101 operating under the control of an operating system. These computer programs 101 transmit requests to the server computer 110 for performing various functions and receive data from the server computer 110 in response to the requests. The server computer 110 also operates under the control of an operating system, and executes one or more computer programs. These computer programs receive requests from the client computer 100 for performing various functions and transmit data to the client computers 100 in response to the requests.

The present invention could be generally implemented using four major components executed by client computers 100 and server computers 102, including a client Web Browser program 101, object framework provided by the current invention 111, data structures 112 and database 120, wherein each of these components comprise instructions and/or data. The client Web Browser program 101 provides a Client User Interface, the object framework provided by the current invention 111 performs application functions on the data structures 112 which are retrieved and stored to the database 120.

Thus, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope of the present invention. Those skilled in the art will recognize that any combination of the above components, or any number of different components, including computer programs, peripherals, and other devices, may be used to implement the present invention, so long as similar functions are performed thereby.

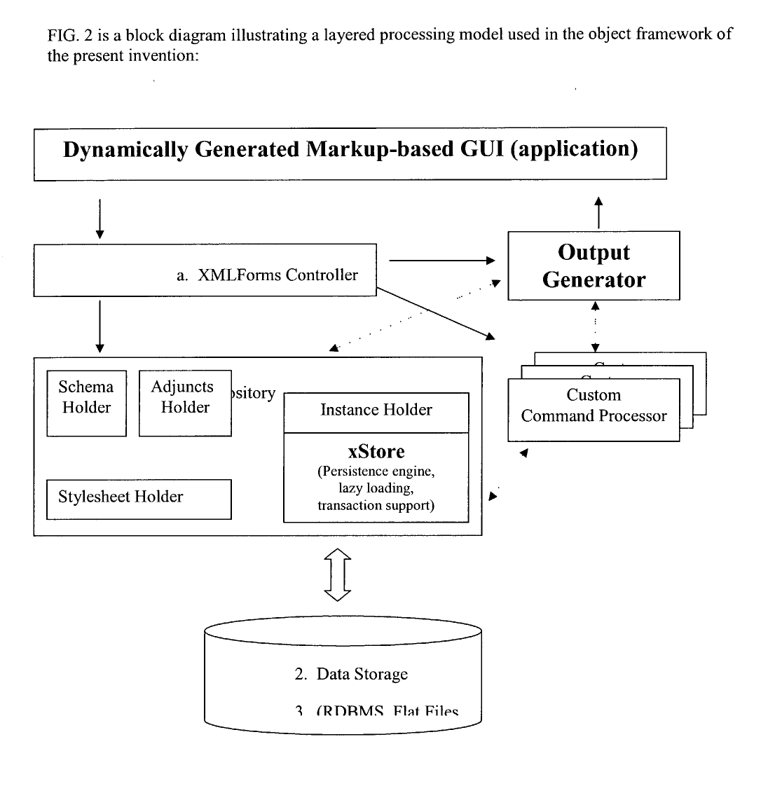

FIG. 2 illustrates the layered architecture used by the object framework of the invention. Data are read from the underlying data storage by the XStore component and mapped into a canonical XML format depending on the specific XML Schema used. A repository holds the necessary Schemas, Schema Adjuncts and Stylesheets needed for processing. The XMLForms Controller mediates between the Graphical User Interface and the Output Controller that is used to translate the data into the appropriate Forms and Reports that make up the Graphical User Interface, The XMLForms Controller also receives events (generally triggered by user actions) and communicates them back to the Output Generator and Repository. Custom Command Processors are used whenever specific processing is needed that cannot be handled by the generic controller and Output Generator.

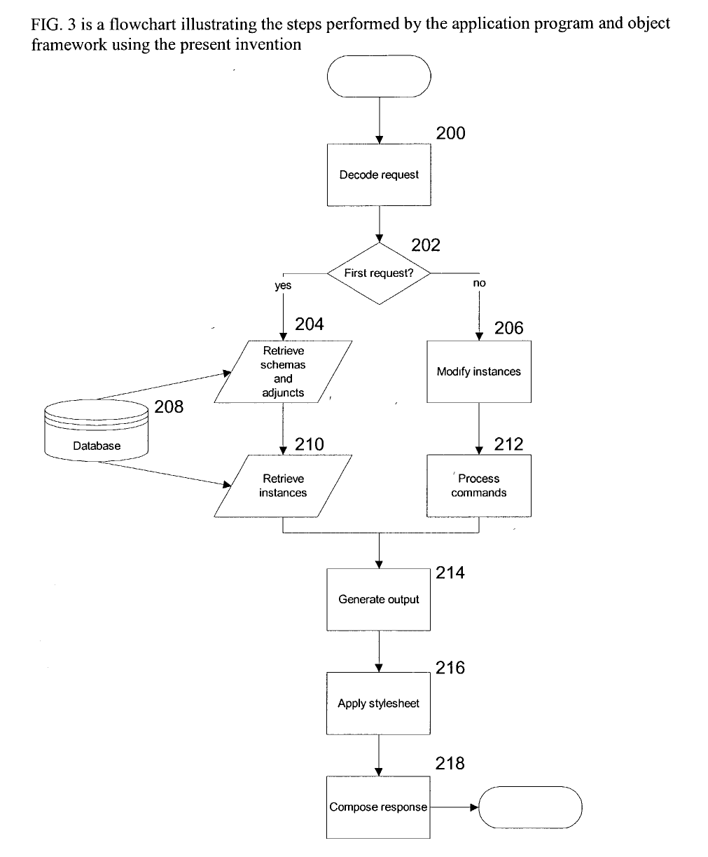

FIG. 3 is a flowchart illustrating the steps performed by the application program 101 and objects framework 111 of the present invention. Block 200 represents the objects framework 111 of the present invention receiving and parsing user input received from a computer program 101 (web browser) via the server computer 110 (web server). Usually, the input is in a Hyper Text Transfer Protocol (HTTP) format, although other protocols may be used as well. Block 202 is a decision block that represents the objects framework 111 of the present invention determining whether the request from a computer program 101 is the first request. If this request is the first request, control transfers to Block 204; otherwise, control transfers to Block 206.

Block 204 represents the object framework 111 of the present invention retrieving XML Schema and Schema Annotations (Schema Adjuncts) data from the database 208. Thereafter, control transfers to Block 210. Block 210 represents the object framework 111 of the present invention retrieving one or more XML Instances data that encapsulate data conformant to XML Schema meta-definitions from the database 208. Thereafter, control transfers to Block 214. Block 206 represents the object framework 111 of the present invention modifying one or more XML Instances that have been retrieved and held on the server computer 110 after a computer program 101 (web browser) submitted its first request. Thereafter, control transfers to Block 212.

Block 212 represents the object framework 111 of the present invention processing, dispatching, and executing set of commands via dedicated Command Processors that have been registered to perform custom business logic processing including enterprise resources access, etc. Thereafter, control transfers to Block 214.

Block 214 represents the object framework 111 of the present invention processing one or more XML Instances that encapsulate data conformant to XML Schemas meta-definitions by applying special algorithms called ‘Output Components’ resulting in generation of one or more display forms and reports, wherein the display forms and reports serve as Graphical User Interface to create, display and modify the data. Thereafter, control transfers to Block 216.

Block 216 represents the object framework 111 of the present invention applying a generic output stylesheet “Other References” to process output Schema Annotations (Schema Adjuncts) and to thus define look and feel of data presentation, which is reusable through a variety of different Web applications working with entirely different metadata. Block 218 represents the object framework 111 of the present invention replying to the application program 101 (web browser) via the server computer 110 (web server). Usually, the output is in an HTML, although other formats or protocols may be used as well.

A further embodiment of the present invention includes Modeling Markup-based User interface with XML Schemas. The present invention uses meta-data structures defined by various XML Schema Languages for dynamic generation of Markup-based User Interfaces, which allows working with any data conformant to those structures. From that perspective, XML Schemas are of central importance when modeling a Markup-based application with present invention. For the purpose of using the current invention for GUI generation, it is possible to either write an XML Schema from scratch or to use a schema from existing business library such as xCBL, RosettaNet and cXML.

In order to use a physical schema file, it must first be parsed to expose the appropriate schema interfaces. The schema interfaces thus act as an abstraction that keeps processing code independent of the schema language used, a big advantage considering the current number of competing syntaxes, as well as legacy DTDs. The present invention parsing framework layer therefore takes different Schema Languages and represents them further with the Unified Abstract Schema Interfaces. The preferred embodiment supports DTD, SOX or XSDL. Due to the concept of Unified Abstract Schema Interfaces, any other schema language support could be added easily without any impact on all the other layers of present invention.

Schema languages define application metadata structures. This information is generic and thus could be used in variety of applications. However, there are some types of information (e.g. the length of specific fields) that cannot be modeled using standard schema facilities. It is therefore necessary to augment the schema with additional information if something more than a very generic presentation is desired. For that specific purpose, the present invention utilizes the Schema Adjuncts concept proposed by Extensibility, which describes a specific approach to augmenting Schemas with extra information. This approach offers a high level of technical applicability and potential for becoming a standard supported by major industry players.

Schema adjuncts are name/value pairs tied to a specific portion of a schema, which can be the schema itself, an element or an attribute. They are represented in a text file with the following format:

<schema-adjunct target=“...”

xmlns:presentation=“...”
xmlns:sql=“...”
xmlns:validation=“...”
...>

<schema>

<sql:server>Myserver</sql:server>
<sql:database>InvoiceDatabase</sql:database>

</schema>
<element which=“Invoice”>

<sql:table>Invoices</sql:table>

</element>
<attribute which=“Invoice/@RefNo”>

<validation:initialValue>generateUUID( ) </validation:initialValue>
<sql:column>InvoiceId</sql:column>

</attribute>

<element which=“TotalPrice”>

<presentation:length>short</presentation:length>
<presentation:editable>false</presentation:editable>
<sql:transient>true</sql:transient>
<validation:calculate>sum(//Invoice/Item/Price)</validation:calculate>

</element>
</schema-adjunct>

Categories of adjuncts are identified using a namespace prefix (“sql”, “presentation” and “validation” in this example). This has the advantage of allowing adjuncts with unstructured content to be added directly to the schema (a process known as adornment):

<element type=“Invoice” sql:table=“sql:Invoices”>

Schema adjuncts are identified using a pattern expressed in a subset of XPath. This means that elements can be identified not only by name, but also by restricting, for instance, the direct parent of the element. In addition, attributes can be referenced and assigned adjuncts using this approach.

Presentational semantics represent a typical example of using Schema Adjuncts to provide generic information about the presentation of element types that can be interpreted as desired by the application stylesheet. They thus enable the generation of complete user interfaces using only schema-level information, with no need to bind specific presentation information to each application page. To illustrate, consider the Film schema below.

Sample Film Schema, Commerce One SOX library

<?xml version=“1.0”?>
<!DOCTYPE schema SYSTEM
“urn:x-commerceone:document:com:commerceone:xdk:xml:schema.dtd$1.0”>
<schema uri=“urn:x-commerceone:document:sample:xdk:sox:Film.sox$1.0”>

<elementtype name=“Film”>

<model>

<sequence>

<element name=“Director” type=“Crew” occurs=“?”/>

<element name=“Actor” type=“Crew” occurs=“*”/>

</sequence>

</model>
<attdef name=“Name” datatype=“string” >

<required/>

</attdef>
<attdef name=“Genre” datatype=“FilmGenre”>

<required/>

</attdef>
<attdef name=“Length” datatype=“int”>

<required/>

</attdef>
<attdef name=“ReleaseYear” datatype=“Year”>

<implied/>

</attdef>

</elementtype>
<elementtype name=“Crew”>

<model>

<element name=“PreviousFilm” type=“FilmSummary”

occurs=“*”/>

</model>
<attdef name=“Name” datatype=“string”>

<required/>

</attdef>
<attdef name=“Gender”>

<enumeration datatype=“NMTOKEN”>

<option>male</option>
<option>female</option>

</enumeration>
<required/>

</attdef>

</elementtype>
<elementtype name=“FilmSummary”>

<empty/>
<attdef name=“Name” datatype=“string”>

<required/>

</attdef>
<attdef name=“ReleaseYear” datatype=“Year”>

<required/>

</attdef>

</elementtype>
<datatype name=“FilmGenre”>

<enumeration datatype=“string”>

<option>Comedy</option>
<option>Drama</option>
<option>Sci-fi</option>
<option>Thriller</option>
<option>Action</option>
<option>Western</option>

</enumeration>

</datatype>
<datatype name=“Year”>

<scalar datatype=“int” digits=“4” minvalue=“1880”/>

</datatype>

</schema>

Additional information is needed to enable the stylesheet to customize the display of data based on this schema. For one thing, the relative length of the fields must be specified. This can be accomplished using a Presentational Semantics item called “length.” This might have possible values of “very short”, “short”, “medium”, “long” and “multiline.” These values are indicative of a very important point about the nature of presentational semantics, namely that they must be sufficiently abstract to be bound to the schema and not to a page that use the schema. By stating that a field is “short” rather than, say, “50 pixels”, the field can be presented correctly regardless of where it is used (in a form or report, in an HTML page or WAP document, etc.). This means that the presentational semantics need only be specified once for a given schema.

To give a further example, we might want to indicate that a Film's Name and Genre belong to the same abstract group of data. This gives further hints to the stylesheet about how to present the data (e.g. on one line in a form). This could be accomplished using a PS called “group” that associates element types belonging to a given group to a unique identifier. The Name and Genre could thus be assigned to a group called “NameGenre”, indicating that they belong together in some abstract way (the exact implication of this fact being determined by the specific stylesheet used).

The following Table 1.0 provides some further examples of presentational semantics that will be necessary to provide the full range of presentation information to the application stylesheet. This list is in no way meant to be exhaustive. It is intended only to provide more clarification as to the nature of these semantics.

TABLE 1.0

| Name | Values | Description |
|---|---|---|
| Label | (free text) | A textual label to use when displaying the |
| | | element. |
| Visible | yes, no | Whether the field should be displayed. |
| importance | low, medium, | How central the information in the field is |
| | high | to the overall object. Could be used to |
| | | determine which fields to use in a basic |
| | | vs. an advanced search form. |
| Editable | yes, no | Whether the field can be modified by the |
| | | user. Might be “no” for machine- |
| | | generated fields. |
| Choices | URI | A pointer to a data source that contains the |
| | | valid values for this element. Used, for |
| | | example, for elements in input forms that |
| | | should be represented with a dropdown |
| | | list. |

Validation is another typical example of using the Schema Adjuncts Concept in the present invention. The idea behind is that while the present invention takes care of automatic validation by constraints defined in an XML Schema, for application purposes it is common requirement to provide a mechanism for binding application-specific business logic.

<element which=“PrintingResponse/accountInfo”>
<validation:executor>

<command>Update</command>
<execution_time>Before After</execution_time>
<execution_class>com.schemantix.validation.CheckAccountInfo</execution_class>

</validation:executor>
</element>

In adjunct fragment above we bind specific application validation logic to a concrete schema element called accountInfo. In addition, in the present invention it is possible to define binding on global level, e.g. for each command and also on Schema level, e.g. for a specific data type or XPath expression.

ExDOM is memory-resident tree-based representation of an XML document. It extends the standard DOM (Document Object Model). Because processing instances in the present invention requires frequent, context-sensitive access to schema information, the ExDOM includes additional nodes that correspond to structures that are present in the schema but only implicit in the document instance.

In ExDOM, the standard DOM is extended in two ways. Firstly, each standard DOM node (Element, Attr, etc.) has a method (getElementType, getAttributeType, etc.) that returns the corresponding node in the schema tree. Using Unified Abstract Schema Interfaces, meta-information about the node can be retrieved. For example, the set of possible values for an enumerated type can be retrieved and used to generate the options for a combo box in a form. Secondly, the ExDOM uses additional nodes to provide information about the underlying structure of the document. XML documents have relatively flat structure compared to their schema, and this makes it impossible to generate rich user interface components that take into account the schema structure. Consider the following XML document:

<address>

<name>John Doe</name>
<street>123 Main St.</street>
<street>Apartment 1</street>
<street>Fifth Floor</street>
<city>New York</city>
<state>New York</state>
<phone>212-555-1111</phone>
<phone>212-555-1112</phone>

</address>

This simple document could correspond to any number of possible schemas. One possibility is that all nodes are on the same level:

<elementtype name=“address”>

<model>

<element name=“name” type=“string”/>
<element name=“street” type=“string”/>
<element name=“street” type=“string”/>
<element name=“street” type=“string”/>
<element name=“city” type=“string”/>
<element name=“state” type=“string”/>
<element name=“phone” type=“string”/>
<element name=“phone” type=“string”/>

</model>

</elementtype>

Another possibility is that the repeated nodes (street and phone) use a single declaration in the schema that can occur multiply:

<elementtype name=“address”>

<model>

<element name=“name” type=“string”/>
<element name=“street” type=“string” occurs=“+”/>
<element name=“city” type=“string”/>
<element name=“state” type=“string”/>
<element name=“phone” type=“string” occurs=“*”/>

</model>

</elementtype>

In a standard DOM, the instance always has the same tree structure regardless of the structure of the corresponding schema. In ExDOM, the instance would have a different structure depending on the schema.

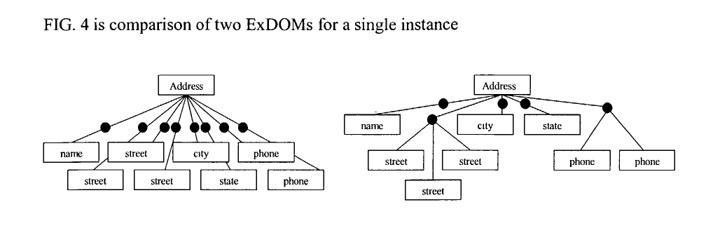

FIG. 4 is comparison of two ExDOMs for a single instance. The black circles represent occurrence nodes. The important difference is that, in the second case 11, a single occurrence node 21, 24 is attached to multiple children for the multiply occurring nodes (street and phone). This enables the code processing the instance to take intelligent action based on the schema without having to perform the complicated task of merging instance and schema (since this is done by the ExDOM parser). Importantly, the ExDOM can always be used as a normal DOM simply by using standard DOM methods to navigate the tree. Only when the ExDOM methods are used (e.g. getExtendedChildNodes rather than getChildNodes) does the additional structure become apparent.

An ExDOM can also be generated from a schema without an instance using the EmptyInstanceFactory. In this case, it represents the minimal valid document conforming to the schema (without any optional attributes and with elements occurring the minimum allowed number of times). This is useful, for instance, in order to generated an input form for creating a new object when an instance does not yet exist.

A ChoiceNode is used when the schema provides the option of several different children for a given node. The interface includes a method getEmptyChoices that returns a list of empty instances (i.e. minimal ExDOM trees) for each of the possible children. A SequenceNode is used when the schema groups elements together in a sequence.

As it turns out, ChoiceNodes and SequenceNodes alone are not sufficient to represent all possible schema structures. The sample ExDOM trees given in FIG. 4 illustrates this. An additional type of node is needed to differentiate the two structures. This node is called an OccurrenceNode. Although OccurrenceNodes are only strictly needed in certain cases, in a preferred embodiment all nodes have an OccurrenceNode parent. This simplifies tree processing, since the use of these nodes is always consistent. In addition, it means that vital methods can be attached to the OccurrenceNode with the certainty that they will be available for each node. In particular, the methods getMinOccurs and getMaxOccurs return the minimal and maximum cardinality of the node. Moreover, the method getEmpty returns a minimal instance of the OccurrenceNode's children. This makes it easy to create and add a new child to the node.

Sample of ExDOM representation:

Consider the following XML file:

```
<?xml version=“1.0” encoding=“UTF-8” ?>
<?soxtype urn:x-commerceone:document:sample:xdk:sox:Film.sox$1.0?>
<Film Name=“Gone With the Wind” Genre=“Thriller”>
  <Director>
  <Crew Name=“Victor Fleming” Gender=“male” >
    <PreviousFilm>
```

<FilmSummary Name=“Treasure Island” ReleaseYear=“1934” />

```
    </PreviousFilm>
    <PreviousFilm>
```

<FilmSummary Name=“Wizard of Oz” ReleaseYear=“1939” />

```
    </PreviousFilm>
  </Crew>
  </Director>
  <Description>A very funny bloody horror </Description>
</Film>
```

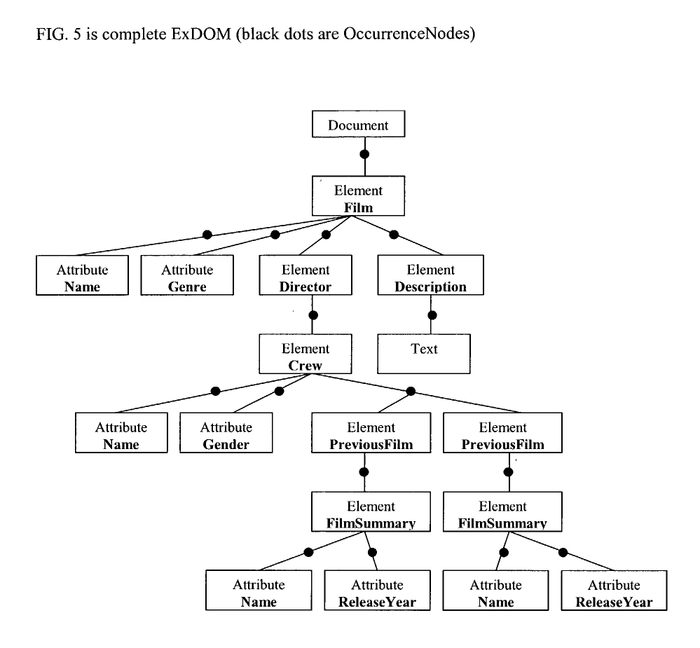

This instance corresponds to the sample SOX schema found in the appendix. FIG. 5 is complete ExDOM (black dots are OccurrenceNodes).

Despite our goal to keep DOM a subset of ExDOM, in ExDOM, the data type is not attached to the Element node, but to its child. There is currently one remaining difference:

Representation of Data Types

There is another importance difference between ExDOM and standard DOM implementations. While a standard DOM is loaded in memory at once and is therefore subject to both memory consumption and performance limitations, the implementation of ExDOM supports so-called “lazy loading”, where the tree is processed as if it were in memory, but in reality only a small part of a tree is present in memory at any given time. Except for caching, only one tree node is in memory at a given time.

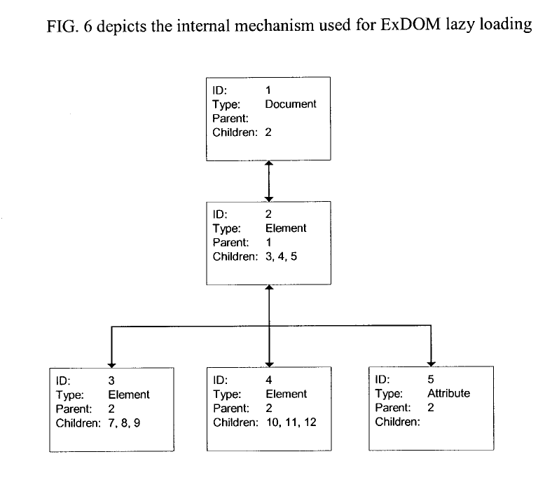

FIG. 6 explains the internal mechanism used by ExDOM lazy nodes. Each ExDOM node has unique ID, which is a unique identifier of corresponding object in the underlying data storage. In addition, each node knows all the unique IDs of its children. When traversing the ExDom tree, nodes are loaded on demand using their IDs. Along with caching, this allows very efficient control over both the memory consumption and performance and memory issues.

Output generation is one of the key features provided by the current invention. After one or more ExDOM trees are built in memory, they are processed by special algorithms called Output Components. Output Components, instantiated as objects within the Output Generator object framework, produce a Markup-based Graphical User Interface (application). Output Components can contain other Output Components. While from an implementation perspective Output Components are algorithms, their presentation in terms of using the present invention for application development is fully conformant to the standard object-oriented paradigm.

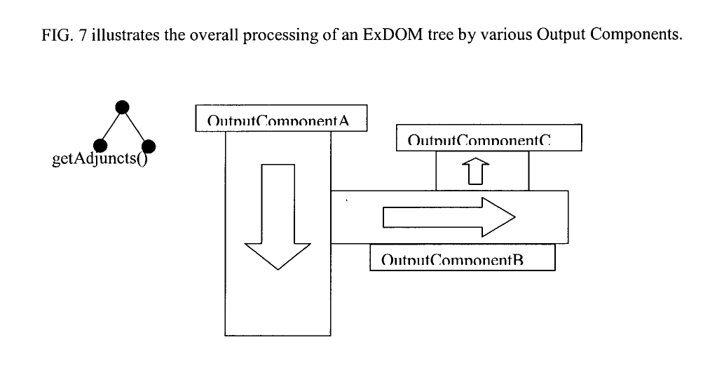

As has been stated in the previous section, from an implementation perspective Output Components are algorithms. FIG. 7 depicts overall processing of an ExDOM tree by various Output Components. Initially, Output Component A starts the process of traversing the tree and applying its algorithm for generating specific type of markup output. While traversing the tree, it uses getAdjunct method of ExDOM node to check whether there is a special type of adjunct registered. The adjunct tells which Output Component should be used for processing the node. For example, if the node has an adjunct telling that OutputComponentB should be used for output generation the control will be transferred to OutputComponentB algorithm which continues in traversing the node and its entire subtree until it either reaches the deepest node or finds another adjunct specifying a different OutputComponent to transfer control to. When the process of processing the node is finished the control is returned back to OuputComponentA.

Output Components can also be considered as objects. Output Components take advantage of object-oriented mechanisms in the similar way to XML. The current invention provides implementation for the fundamental set of Output Components in the Java programming language. From viewpoint of an user of the current invention, it is possible to create new Output Components by extension—deriving new component types from an existing ones, or by composition—using aggregation for creating new component types.

The current invention provides functionality for dynamically generating Markup-based User Interface as forms and reports. The output is generated on the basis of an ExDOM tree, which can be built either from a schema alone or from a combination of a schema and an instance. As much of the actual logic determining how the final page should appear is offloaded to the stylesheet, as the developer will control this process by modifying the transformation rather than changing the engine of the current invention. The goal is therefore to output sufficient information to enable the stylesheet author flexibility in establishing how the output should be presented.

A special view interface is used to generate the textual output. This decouples the actual format of the output from the logic used to generate it. The output document is built up as a tree, with paragraph (“p”) tags delimiting the hierarchical levels, and “input” tags used to represent the output fields. Schema adjuncts are output for each field as attributes on the appropriate “input” (or “select”) tag. If a given element has an adjunct called “length” set to “long”, the corresponding “input” tag in the output document would have an attributed called “length” with a value of “long”.

Stylesheet processing is a simple transformation from the generic XHTML created by the current invention into the final output format. A very important fact is that stylesheet typically used in the current invention is a generic one, which means it can be reused in variety of applications working with different application data structures. The stylesheet is typically used to define application look-and-feel and is not directly related to specific application metadata. The idea behind is to process nodes based on Schema Adjuncts rather than the data itself. So for example, if stylesheets finds a Schema Adjunct value holding the value “long” it might generate an input field with extended length; the meaning of what this long length is might vary depending on the required look-and-feel, operating environment and other factors.

In summary, the present invention discloses a method, apparatus, and article of manufacture for generating a Web-based Graphical User Interface (application) within an extensible application framework with links to enterprise resources based on variety of XML Schema languages such as DTD, SOX, and XSDL.

The foregoing description of the preferred embodiment of the invention has been presented for the purposes of illustration and description. It is not intended to be exhaustive or to limit the invention to the precise form disclosed. Many modifications and variations are possible in light of the above description. It is intended that the scope of the invention be limited not by this detailed description, but rather by the claims appended hereto. While the invention herein disclosed has been described by means of specific embodiments and applications thereof, numerous modifications and variations could be made thereto by those skilled in the art without departing from the scope of the invention set forth in the claims.

What is claimed as new and desired to be protected by Letters Patent of the United States is:

1. A computerized method for generating a Markup-based Graphical User Interface (application), comprising the steps of:
(a) modeling generic application metadata with at least one of extensible Markup Language (XML) Schema languages;
(b) using Schema Annotations (Schema Adjuncts) for definition of application-specific features;
(c) processing said at least one of XML Schema languages into Unified Abstract Schema Interfaces and representing them further with Unified Abstract Schema Interfaces;
(d) analyzing application data and merging said application data with XML Schema information to produce one or more conceptual Extended Document Object Model (ExDOM) trees;
(e) processing at least one conceptual ExDOM trees that encapsulate data conformant to XML Schemas definitions by applying ‘Output Components’ algorithms, which are instantiated as objects within an object framework, wherein the object framework provides a layered processing model that corresponds to application views, XML Schema definitions and data defined and stored in the underlying data storage; and
(f) generating one or more display forms and reports, wherein said display forms and reports serve as Graphical User Interface to create, display and modify the data conformant to XML metadata definitions.

2. The method of claim 1, wherein said at least one Schema Languages comprises at least one of Document Type Definition (DTD), Schema for Object-oriented XML (SOX) and XML Schema Definition Language (XSDL).

3. The method of claim 1, wherein said XML Schemas Languages are parsed into Unified Abstract Schema Interfaces and represented further with Unified Abstract Schema Interfaces.

4. The method of claim 1, wherein said Schema Annotations (Schema Adjuncts) are used to model different aspects of specific application level behavior of at least one of presentation details, enterprise resource mappings and application flow.

5. The method of claim 1, wherein said generic application metadata is conceptually merged with Data-Level information into an ExDOM tree or ExDOM.

6. The method of claim 1, wherein said “Output Components” are applied to said ExDOM in order to produce an Abstract Output Document.

7. The method of claim 1, wherein said different Abstract Output Document implementations enable the production of various target output formats from at least one of XML, HyperText Markup Language (HTML), extensible HTML (XHTML) and Portable Document format (PDF).

8. The method of claim 1, wherein a generic output stylesheet Other References with no dependencies on the specific Schema being processed is used to process output Schema Annotations (Schema Adjuncts) and to thus define the look and feel of the data presentation, which is reusable through variety of different WEB applications working with entirely different metadata.

9. The method of claim 1, wherein the display forms are selected from a group comprising input forms and reports.

10. The method of claim 9, wherein the said input forms and reports include hidden commands that are used to construct specific server-side requests automatically after a user has submitted client-side actions.

11. The method of claim 10, further comprising the steps of automatic server-side dispatching and executing a set of commands by dedicated Command Processors.

12. The method of claim 11, wherein a custom Command Processor could be registered to execute custom processing including enterprise resources access.

13. The method of claim 11, wherein display forms and reports containing hidden commands are generated automatically as a response to user actions.

14. The method of claim 6, wherein said ExDOM tree is constructed dynamically on an “as-needed” basis using a lazy loading process while being processed by various Output Components algorithms.

15. A computerized apparatus for generating WEB applications, comprising:
(a) a computer with a WEB server;
(b) dynamic processor means, performed by the computer, for processing various XML Schema languages into Unified Abstract Schema Interfaces and representing them further with the Unified Abstract Schema Interfaces;
(c) dynamic processor means, performed by the computer, for analyzing application data and merging it with Schemas information to produce a conceptual ExDOM tree; and
(d) dynamic processor means, performed by the computer, for further processing of one or more conceptual ExDOM trees that encapsulate data conformant to XML Schemas definitions by applying special algorithms called Output Components which are instantiated as objects in an object framework, wherein the object framework provides a layered processing model that corresponds to application views, XML Schema definitions, and data defined and stored in the underlying data storage.
(f) dynamic processor means, performed by the computer, for generating at least one of display forms and reports, wherein said display forms and reports are used to perform at least one of creating, displaying and modifying the data conformant to those definitions provided by said XML Schemas.

16. The apparatus of claim 15, wherein different XML Schemas Languages are parsed into and represented with Unified Abstract Schema Interfaces.

17. The apparatus of claim 15, wherein Schema Annotations (Schema Adjuncts) are used to model different aspects of specific application level behavior selected from a group comprising presentation details, enterprise resources mappings, and application flow.

18. The apparatus of claim 15, wherein Schema Level Metadata Information is conceptually merged with Data Level information into an ExDOM tree or ExDOM.

19. The apparatus of claim 15, wherein reusable special algorithms called Output Components are applied to the ExDOM data structure in order to produce the Abstract Output Document.

20. The apparatus of claim 15, wherein different Abstract Output Document implementations allow producing various target output format from the group comprising at least one of XML, XHTML, HTML and PDF.

21. The apparatus of claim 15, wherein a Generic Output Stylesheet, with no dependencies on the specific Schema being processed, is used to process Schema Annotations (Schema Adjuncts) and to thus define look and feel of data presentation, which is reusable through variety of different WEB applications working with different metadata.

22. The apparatus of claim 15, wherein the display forms are selected from a group comprising input forms and reports.

23. The apparatus of claim 22, wherein the input forms and reports include hidden commands that are used to automatically construct specific server-side requests after a user has submitted client-side actions.

24. The apparatus of claim 23, further comprising the step of automatic server-side dispatching and executing a set of commands by dedicated Command Processors.

25. The apparatus of claim 24, wherein a custom Command Processor could be registered to execute custom business logic processing including at least enterprise resources access.

26. The apparatus of claim 24, wherein display forms and reports containing hidden commands are generated automatically as a response to user actions.

27. The apparatus method of claim 19, wherein the ExDOM tree is constructed dynamically on an ‘as-needed’ basis using lazy loading while being processed by various Output Components algorithms.

28. An article of manufacture comprising a computer program carrier embodying one or more instructions that, when executed by a computer, causes the computer to perform method steps for generating a WEB application based on variety of XML Schema languages including at least one of DTD, SOX, and XSDL, the method comprising the steps of:
(a) modeling generic application metadata with variety of XML Schemas languages including at least one of DTD, SOX and XSDL;
(b) using Schema Annotations (Schema Adjuncts) for application-specific features definition;
(c) processing various XML Schema languages into Unified Abstract Schema Interfaces Data Structures and representing them further with said Unified Abstract Schema Interfaces Data Structures;
(d) analyzing application data and merging it with XML Schemas information to produce one or more conceptual ExDOM trees;
(e) further processing of one or more conceptual ExDOM trees that encapsulate data conformant to XML Schemas definitions by applying special algorithms called Output Components, which are instantiated as objects in an objects framework, wherein the objects framework provides a layered processing model that corresponds to application views, XML Schema definitions, and data defined and stored in the underlying data storage; and
(f) generating one or more display forms and reports, wherein the display forms and reports are used to create, display and modify the data conformant to those definitions.

29. The method of claim 28, wherein said XML Schemas Languages are parsed into and represented further with the Unified Abstract Schema Interfaces Data Structures.

30. The method of claim 28, wherein Schema Annotations (Schema Adjuncts) are used to model different aspects of specific application level behavior including at least presentation details, enterprise resources mappings and application flow.

31. The method of claim 28, wherein Schema Level Metadata Information is conceptually merged with Data Level information into an Extended DOM tree or ExDOM.

32. The method of claim 28, wherein reusable special algorithms called Output Components are applied to the ExDOM data structure in order to produce the Abstract Output Document.

33. The method of claim 28, wherein different Abstract Output Document implementations allow producing various target output format in at least one of XML, XHTML, HTML and PDF.

34. The method of claim 28, wherein a Generic Output Stylesheet with no dependencies on the specific Schema being processed is used to process Schema Annotations (Schema Adjuncts) and to thus define look and feel of data presentation, which is reusable through variety of different WEB applications working with different metadata.

35. The method of claim 29, wherein the display forms are selected from a group comprising input forms and reports.

36. The method of claim 35, wherein the input forms and reports include hidden commands that are used to automatically construct specific server-side requests after a user has submitted client-side actions.

37. The method of claim 36, further comprising the step of automatic server-side dispatching and executing a set of commands by dedicated Command Processors.

38. The method of claim 36, wherein a custom Command Processor could be registered to execute custom processing including at least enterprise resources access.

39. The method of claim 36, wherein display forms and reports containing hidden commands are generated automatically as a response to user actions.

40. The method of claim 32, wherein said ExDOM tree is constructed dynamically on ‘as-needed’ basis using lazy loading while being processed by various Output Component algorithms.
